(19) United States
(12) Patent Application Publication
(10) Pub. No.: US 2023/0313006 A1
(43) Pub. Date: Oct. 5, 2023

(54) PRIMER FOR POLYURETHANE ADHESIVE

(71) Applicant: DDP SPECIALTY ELECTRONIC MATERIALS US, LLC, Collegeville, PA (US)

(72) Inventors: Thomas Clark, Auburn Hills, MI (US); Niranjan Malvadkar, Auburn Hills, MI (US); Daniel P. Sophiea, Auburn Hills, MI (US); Huide Zhu, Auburn Hills, MI (US)

(21) Appl. No.: 18/023,528

(22) PCT Filed: Aug. 11, 2021
(86) PCT No.: PCT/US2021/045480

§ 371 Date: Feb. 27, 2023

Related U.S. Application Data
(60) Provisional application No. 63/072,350, filed on Aug. 31, 2020.

(51) Int. Cl. C09J 175/06; C08G 18/22; C08G 18/67; C08G 18/38; C08G 18/08; C08G 18/12; C09J 5/02

(52) U.S. Cl. CPC C09J 175/06; C08G 18/222; C08G 18/677; C08G 18/3893; C08G 18/0852; C08G 18/12; C08G 18/0885; C09J 5/02

(57) ABSTRACT

A method is provided for bonding substrates having dissimilar coefficients of thermal expansion, using a thermoset adhesive. The method involves a pre-cure step using radio-frequency energy, followed by a heat-curing step.

### FIELD OF INVENTION

The present invention relates to the field of primers, particularly glass-bonding primers for use with polyurethane adhesives.

### BACKGROUND OF THE INVENTION

Glass bonding primers typically contain organic solvents, organosilane intermediates, isocyanate prepolymers, film formers, carbon black, catalysts, and stabilizers. Preparation of these primers involves several complex steps which increases cycle times thereby raises manufacturing costs. For instance, incorporation of carbon black in the primer formulation requires a separate milling step, which is time-consuming and energy-intensive. Besides, carbon black also has poor stability in the primer and therefore tends to settle at the bottom of the bottle. As a result, prior to application of the primers, the primer bottle requires continuous vigorous shaking to re-disperse the carbon black. A clear primer without a milling step is therefore highly desirable.

Another sought after property of primers is extended open time. Open time is defined as the time between application of the primer on the glass surface and the application of the urethane adhesive. As the primer is applied, the solvent evaporates and leaves behind a film of functional groups that can link up to the functional groups in the urethane (e.g., isocyanates). As the primer film ages, the functional groups in the primer layer can react with moisture or can get oxidized, both resulting in loss of functionality. As a result, the primer performance deteriorates as the primer layer ages. Most primers therefore have limited open time. However, the automotive industry demands primers with long open times to have enough cushion time between application of the primer and application of the urethane adhesive. In many cases, the glass used by automotive OEMs are supplied for tier 1 suppliers. These suppliers send primed glass to the OEMs, who apply the urethane adhesive during vehicle assembly. The urethane adhesive must be applied to the primed glass within the specified open time of the primer. If the urethane is not applied within the specified open time, the glass must be sent back for repriming, which increases production costs for the OEMs. As a result, a primer with long open time is highly desirable.

### SUMMARY OF THE INVENTION

In a first aspect, the invention provides a primer composition for urethane-based adhesives, comprising: a) at least one adhesion promoter; b) at least one catalyst; c) at least one solvent; and d) at least one blocked amino-silane with the following formula:

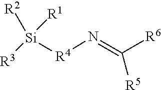

where R¹ is OCH₃ or OC₂H₅;
R² and R³ are independently selected from OCH₃, OC₂H₅, and CₘH₂ₘ₊₁ where
m is an integer of 1 to 5;
R⁴ is CₙH₂ₙ where n is an integer of 1 to 12;
R⁵ is H or CₚH₂ₚ₊₁, branched or unbranched, where p is an integer of 1 to 10;
R⁶ is C_{q}H_{2q+1}, branched or unbranched, where q is an integer of 1 to 10.

In a second aspect, the invention provides a method for priming a substrate, comprising the step or applying on the surface of the substrate a primer comprising: a) at least one adhesion promoter; b) at least one catalyst; c) at least one solvent; and d) at least one blocked amino-silane with the following formula:

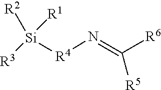

where R¹ is OCH₃ or OC₂H₅;
R² and R³ are independently selected from OCH₃, OC₂H₅, and CₘH₂ₘ₊₁ where
m is an integer of 1 to 5;
R⁴ is CₙH₂ₙ where n is an integer of 1 to 12;
R⁵ is H or CₚH₂ₚ₊₁ where p is an integer of 1 to 10;
R⁶ is C_{q}H_{2q+1} where q is an integer of 1 to 10.

In a third aspect, the invention provides a method of adhering a first and second substrate, comprising the steps of:
(1) applying to the surface of the first substrate, the second substrate or both a primer comprising: a) at least one adhesion promoter; b) at least one catalyst; c) at least one solvent; and d) at least one blocked amino-silane with the following formula:

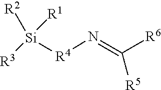

where R¹ is OCH₃ or OC₂H₅;
R² and R³ are independently selected from OCH₃, OC₂H₅, and CₘH₂ₘ₊₁ where
m is an integer of 1 to 5;
R⁴ is CₙH₂ₙ where n is an integer of 1 to 12;
R⁵ is H or CₚH₂ₚ₊₁ where p is an integer of 1 to 10;
R⁶ is C_{q}H_{2q+1} where q is an integer of 1 to 10;
(2) allowing the solvent to evaporate;
(3) applying a polyurethane-based adhesive to the first substrate, the second substrate or both in such a way that it will be in contact with the primer when the substrates are assembled; and
(4) assembling the first substrate and second substrate such that the adhesive is sandwiched between them.

### DETAILED DESCRIPTION OF THE INVENTION

The inventors have surprisingly found that primers that include specific blocked aminosilanes result in excellent adhesive strength when used in conjunction with a polyurethane-based adhesive, and that the adhesive strength is maintained even after extended open time. The expression “primer” includes any adhesion-promoting coating that is applied to a substrate as a solution in a solvent, with the solvent being sufficiently volatile to be evaporated, leaving a film coating on the substrate. The film is generally less than 1 mm in thickness, preferably in the order of 100 nm-100 microns.

### Definitions and Abbreviations

TDI toluene diisocyanate
HDI hexamethylene diisocyanate
HDI-biuret reaction product of hexamethylene diisocyanate and biuret:

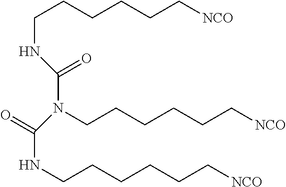

Paraloid QM-1007M

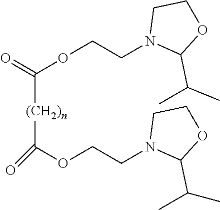

where n is an integer of from 2 to 4
Sivate E610 a blend of aminopropyltriethoxysilane, 1,2-bis(triethoxysilyl)ethane, and bis(3-triethoxysilylpropyl)amine

Molecular weights of polymers as reported herein are reported in Daltons (Da) as number or weight average molecular weights, as determined by size exclusion chromatography (SEC).

Adhesion Promoter

An adhesion promoter is added to the primers of the invention to enhance adhesion to glass or any substrate the primer is applied on. In addition, the adhesion promoter can include functional moieties that form a chemical bond or bonds with the urethane adhesive that is applied on the primer. Suitable adhesion promoters can be selected from various organosilanes, organotitanates, and organozirconates. Preferred adhesion promoters for glass bonding primers are organosilanes, preferably consisting of at least one silicon atom and two or three alkoxy groups, such as methoxy and/or ethoxy groups bound to the silicon atom.

Preferred adhesion promoters are functional silanes, meaning compounds of the general formula (R¹O)₃—Si—R²X or (R¹O)₂—(R³)Si—OR²X, where R¹ is independently selected from a substituted or unsubstituted alkyl group or acyl group, for example methyl, ethyl, 2-methoxyethyl or acetyl, R² is C₂₋₆ alkylene, X is a group functionalized with a glycidyl, amino, mercapto, methacryloxy, or isocyanate group, with amino and isocyanate groups being particularly preferred, R³ is substituted or unsubstituted C₁₋₆ alkyl, with methyl being preferred, and mixtures of these.

Particularly preferred adhesion promoters are amino silanes, that is compounds that have one or more alkoxy silyl groups and one or more amino groups with an alkylene moiety disposed between the alkoxysilyl group and the amine group. The alkylene group may be a C₁₋₂₀, preferably a C₁₋₄ alkylene group. Particularly preferred are ethylene, propylene and butylene. Propylene is particularly preferred. The amine can be primary or secondary and may have a hydroxyalkyl group bonded to the amine nitrogen. Alkoxysilyl groups are groups having a silicon atom bonded to from one to three alkoxy groups; two or three alkoxy groups; or three alkoxy groups. The alkyl groups on the alkoxy moiety may be C₁₋₄ alkyl; ethyl or methyl; or methyl. The alkoxy silyl groups may have 1 or 2 alkyl groups directly bonded to the silicon atom. The alkyl groups bonded to the silicon atom may be C₁₋₄ alkyl; ethyl or methyl; or methyl.

Exemplary amino silanes include 3-aminopropyltrimethoxysilane, 3-aminopropyltriethoxysilane, 3-aminopropyl-dimethoxymethylsilane, 3-amino 2-methylpropyl-trimethoxy silane, 4-aminobutyl-trimethoxysilane, 4-aminobutyldimethoxymethylsilane, 4-amino-3-methylbutyl-trimethoxysilane, 4-amino-3,3-dimethylbutyltrimethoxysilane, 4-amino-3,3-di-methylbutyldimethoxymethylsilane, 2-aminoethyltrimethoxysilane, 2-amino ethyldimethoxymethylsilane, aminomethyltrimethoxysilane, aminomethyl dimethoxymethylsilane, aminomethylmethoxydimethylsilane, N-methyl-3 aminopropyltrimethoxysilane, N-ethyl-3-aminopropyltrimethoxysilane, N-butyl 3-aminopropyltrimethoxysilane, N-cyclohexyl-3-aminopropyltrimethoxysilane, N-phenyl-3-aminopropyltrimethoxysilane, N-methyl-3-amino-2-methylpropyltrimethoxysilane, N-ethyl-3-amino-2-methylpropyltrimethoxysilane, N-ethyl-3-aminopropyldimethoxymethylsilane, N-phenyl-4-aminobutyltrimethoxysilane, N-phenylaminomethyldimethoxymethylsilane, N-cyclohexylaminomethyldimethoxymethylsilane, N-methylaminomethyldimethoxymethylsilane, N-ethyl aminomethyldimethoxymethylsilane, N-propylaminomethyldimethoxymethyl-silane, N-butylaminomethyldimethoxymethylsilane and mixtures thereof. Particularly preferred is aminopropyltriethoxysilane.

Examples of suitable mercaptosilane include 3-mercaptopropyltrimethoxysilane, 3-mercaptopropyltriethoxysilane, 3-mercaptopropyl-methyl-dimethoxysilane.

Also preferred is an adhesion promoter made by reaction of HDI-biuret and 3-mercaptopropyltrimethoxysilane (as disclosed in U.S. Pat. No. 5,238,993, incorporated herein by reference), referred to herein as 170702. The structure when the stoichiometry is 3 isocyanate (NCO) groups to 1 mercapto group is the following:

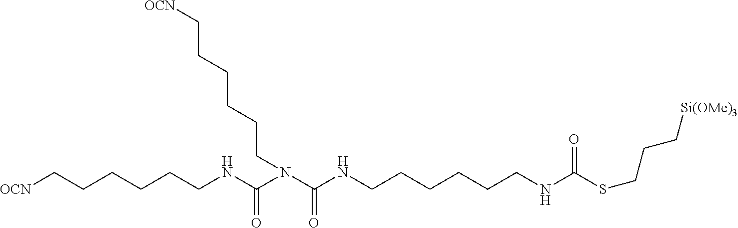

The adhesion promoter is preferably used at from 5 to 30 wt %, more preferably 7 to 25 wt %, particularly preferably 10 to 20 wt %, based on the total weight of the primer.

In a preferred embodiment 170702 is used as adhesion promoter at a concentration of 10 to 20 wt %, based on the total weight of the primer.

In another preferred embodiment, 3-aminopropyltriethoxysilane is used as adhesion promoter, preferably at 0.5 to 5 wt %, more preferably at 1 to 3 wt %, based on the total weight of the primer.

In another preferred embodiment, 3-mercaptopropyltrimethoxysilane is used as adhesion promoter, preferably at 1 to 6 wt %, more preferably 2 to 5 wt %, particularly preferably 3 to 4 wt %, based on the total weight of the primer.

In another preferred embodiment, 3-aminopropyltriethoxysilane and 3-mercaptopropyltrimethoxysilane are used as adhesion promoters, preferably at 0.5 to 5 wt %, more preferably at 1 to 3 wt % 3-aminopropyltriethoxysilane and 1 to 6 wt %, more preferably 2 to 5 wt %, particularly preferably 3 to 4 wt % 3-mercaptopropyltrimethoxysilane, based on the total weight of the primer.

Catalyst

The at least one catalyst is a catalyst that is capable of catalyzing the reaction of isocyanates with moisture.

Particularly preferred catalysts for catalyzing the reaction of isocyanates with moisture are zinc carboxylate-based catalysts.

The catalyst is preferably used at from 0.2 to 5 wt %, more preferably 0.5 to 2 wt %, particularly preferably 1 wt %, based on the total weight of the primer.

In addition, the primer may comprise a catalyst that is capable of catalyzing the reaction of organosilanes with moisture. Preferred such catalysts a Lewis acid catalysts, for example reactive octyleneglycol titanate.

Solvent

The solvent is a volatile component of the primer that can solubilize the other components of the primer from 10° C. to 40° C. The solvent is relatively inert to the other components of the primer. The solvent is preferably aprotic. The solvent is preferably anhydrous to help prevent reaction of functional groups (isocyanate and alkoxysilane) with moisture. Examples of suitable solvents include xylene, methylene chloride, benzene, butyl acetate, monochlorobenzene, trichloroethylene, ethylene chloride, toluene, low molecular weight ketones, such as acetone, and methyl ethyl ketone, and mixtures thereof. Acetone and methyl ethyl ketone are preferred, with MEK being particularly preferred.

Blocked Aminosilane

The primer compositions of the invention comprise at least one blocked aminosilane, having the formula:

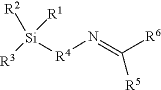

where R¹ is OCH₃ or OC₂H₅;
R² and R³ are independently selected from OCH₃, OC₂H₅, and CₘH₂ₘ₊₁ where
m is an integer of 1 to 5;
R⁴ is CₙH₂ₙ where n is an integer of 1 to 12;
R⁵ is H or CₚH₂ₚ₊₁, branched or unbranched, where p is an integer of 1 to 10;
R⁶ is C_{q}H_{2q+1}, branched or unbranched, where q is an integer of 1 to 10.

In a preferred embodiment, R¹ is OC₂H₅.

In another preferred embodiment, R² and R³ are independently selected from OCH₃, OC₂H₅ and OC₃H₇, more preferably R² and R³ are independently selected from OCH₃ and OC₂H₅, particularly preferably R² and R³ are OC₂H₅.

In another preferred embodiment, R⁴ is CₙH₂ₙ where n is an integer of 1 to 4, particularly preferably n is an integer 1 to 3, more particularly preferably n is 3.

In another preferred embodiment, R⁵ is selected from H or CₚH₂ₚ₊₁, branched or unbranched, where p is an integer of 1 to 5, particularly preferably p is 1, 2 3 or 4, with 1 being particularly preferred.

In another preferred embodiment, R⁶ is selected from C_{q}H_{2q+1}, branched or unbranched, where q is an integer of 1 to 5, preferably q is 2 to 5, with 4 being particularly preferred. More particularly preferably, R⁶ is butyl or iso-butyl.

In a preferred embodiment, R¹ is OC₂H₅, R² and R³ are independently selected from OCH₃, OC₂H₅ and OC₃H₇, more preferably R² and R³ are independently selected from OCH₃ and OC₂H₅, particularly preferably R² and R³ are OC₂H₅, R⁴ is CₙH₂ₙ where n is an integer of 1 to 4, particularly preferably n is an integer 1 to 3, more particularly preferably n is 3, R⁵ is selected from H or CₚH₂ₚ₊₁, branched or unbranched, where p is an integer of 1 to 5, particularly preferably p is 1, R⁶ is selected from C_{q}H_{2q+1}, branched or unbranched, where q is an integer of 1 to 5, particularly preferably q is 4, more particularly preferably R⁶ is butyl or iso-butyl.

In a particularly preferred embodiment, the blocked aminosilane is 3-(1,3-dimethylbutylidene)aminopropyltriethoxysilane:

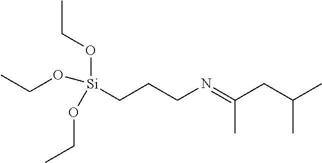 [SMILES: CCO[Si](CCC/N=C(\C)CC(C)C)(OCC)OCC]

The blocked aminosilane can bond to inorganic surfaces such as glass and ceramic frits after hydrolysis. In addition, blocked aminosilanes of this type contain an imine group which is hydrolytically unstable. After reaction with water, the imine group dissociates to form a primary amine-functional silane (in this case, 3-aminopropyltriethoxysilane) and a volatile ketone (methyl iso-butyl ketone). The amine group is available for reaction with isocyanate groups from the urethane adhesive resulting in the formation of substituted urea groups.

Primers containing a blocked aminosilane maintain performance after extended open times. The presence of the blocked aminosilane leads to greater hydrolytic stability and greater retention of bond strength after long open time conditions, which can be demonstrated, for example, by measuring bond strength after hot water immersion. Additionally, the blocked aminosilane groups prevents formation of blisters on the primer surface after exposure to hot water. Significant blistering is observed with primers without the blocked aminosilane after hot water exposure. In addition, the blocked aminosilane shows improved bond strength retention after cataplasma exposure (thermal shock).

The blocked aminosilane is preferably present at a concentration of 0.2 to 4 wt %, more preferably 0.5 to 3 wt %, particularly preferably 1 to 2 wt %, based on the total weight of the primer.

Particularly preferably the blocked aminosilane is 3-(1,3-dimethylbutylidene)aminopropyltriethoxysilane, used at 0.2 to 4 wt %, more preferably 0.5 to 3 wt %, particularly preferably 1 to 2 wt %, based on the total weight of the primer.

Film Former

The compositions of the invention may additionally comprise a film former. The film former that can be used in the primers of the invention is not particularly limited. A film former is a resin capable of forming a thin film on a solid surface. In general, film forming resins are dissolved in a carrier solvent (e.g., organic solvents), which enables application of the resin by various techniques (e.g., spraying, brushing etc.). After applying the film forming resin solution, the solvent evaporates leaving behind a thin film of the resin. The preferred film forming resin is a polymer that is non-reactive and have good compatibility with other components of the primer. In addition, the resin must have good wetting on glass and ceramic frits resulting in a continuous primer film on the surface.

Preferred is a polyester resin of molecular weight from 20,000 to 100,000 Da, suspended or dissolved in a suitable organic solvent, preferably an aprotic solvent that is sufficiently volatile to evaporate under ambient conditions, such as xylene, methylene chloride, benzene, butyl acetate, monochlorobenzene, trichloroethylene, ethylene chloride, toluene, low molecular weight ketones, such as acetone, and methyl ethyl ketone, and mixtures thereof. A particularly preferred solvent is MEK. An example of a suitable polyester is a copolymer of iso-phthalate, dimethyl terephthalate, neo-pentyl glycol and ethylene glycol. Particularly preferred is a copolymer of iso-phthalate, dimethyl terephthalate, neo-pentyl glycol and ethylene glycol, suspended or dissolved in MEK, more particularly preferably at 40 wt %, based on the total weight of the film-former solution/suspension.

The film-former is preferably used at from 5 to 40 wt %, more preferably 10 to 30 wt %, based on the total weight of the primer.

Particularly preferably the film former is a polyester film-forming resin made from iso-phthalate, dimethyl terephthalate, neo-pentyl glycol and ethylene glycol (40% resin in MEK), used at from 5 to 40 wt %, more preferably 10 to 30 wt %, based on the total weight of the primer.

Other Ingredients

The primer may additionally comprise other optional ingredients, for example:
One or more cross-linkers, such as one or more polyisocyanates, for example TDI/HDI polyisocyanate, including latent cross-linkers. A latent cross-linker is a molecule that is non-reactive under storage condition but can be activated through a trigger mechanism such as moisture, which enables cross-linking with reactive groups, such as Paraloid QM-1007;
One or more stabilizers, such as diethyl malonate;

If an isocyanate cross-linker is used, the adhesion promoter cannot be an aminosilane, a mercaptosilane or an organotitanate.

Adhesive

The primer compositions of the invention are suitable for use with any polyurethane-based adhesive.

Typical polyurethane-based adhesive contains at least one isocyanate-terminated urethane prepolymer. The polyurethane adhesives cure by reaction of atmospheric moisture with isocyanate groups although other well-known curing agents can also be used.

In a preferred embodiment, the adhesive is a one-component, moisture curing, high viscosity polyurethane adhesive comprising an MDI based urethane prepolymer. Fillers such as carbon black, clay, calcium carbonate etc. are added for a variety of reasons including to reduce the cost of the adhesive, to add strength or to color the adhesive. In addition, the polyurethane adhesives may contain adhesion promoters (e.g., alkoxysilane) that can be added during adhesive compounding or are present as pendent groups in the urethane prepolymer. The polyurethane adhesives can contain other additives such as plasticizers, stabilizers, thixotropes and the like which are well known to those skilled in the art.

Adhesive compositions are used to affix (bond) glass (windows) into buildings and vehicles, see Rizk, U.S. Pat. No. 4,780,520; Bhat, U.S. Pat. No. 5,976,305; Hsieh et al, U.S. Pat. No. 6,015,475 and Zhou, U.S. Pat. No. 6,709,539, incorporated herein by reference.

In a preferred embodiment, the adhesive comprises a prepolymer made from and/or containing at least one polyol [preferably a poly(propyleneoxide) polyol], a plasticizer (such as diisononyl phthalate), at least one diisocyanate (such as 4,4′-diphenylmethane diisocyanate), a catalyst (such as stannous 2-ethylhexanoate) and a stabilizer (such as diethyl malonate).

The prepolymer (such as those described above), is preferably present in the adhesive at 45-60 wt %, more preferably 50-60 wt %, based on the total weight of the adhesive.

In a particularly preferred embodiment, the adhesive comprises the following:

Isocyanate-terminated prepolymer

| Raw Material | Chemistry |
|---|---|
| Voranol 220-056 | a nominally difunctional, poly(propylene oxide) |
| | having a hydroxyl number of 56 (equivalent weight |
| | 1000) |
| Voranol 232-036N | a nominally trifunctional poly(propylene oxide) |
| | having a hydroxyl number of 36 (equivalent weight |
| | 1558) |
| Palatinol N | Diisononyl Phthalate |
| Isonate 125M | 4,4′-diphenylmethane diisocyanate |
| Dabco T-9 | Stannous 2-Ethylhexanoate |
| Diethyl malonate | Diethyl malonate |

Polyurethane-based adhesive

| Raw Material | Chemistry |
|---|---|
| Isocyanate-terminated prepolymer | |
| (such as the prepolymer described | |
| in the above table) | |
| ELFTEX S7100 | Carbon black |
| Iceburg Clay | Kaolin clay |
| Palatinol N | Diisononyl Phthalate |
| Bismuth Octoate | Bismuth 2-Ethylhexanoate |
| JEFFCAT DMDEE | Morpholine, 4,4′-(Oxydi-2,1- |
| | ethanediyl)bis |

Substrate

The primer compositions of the invention are suitable for use with various substrates, including glass, metal, plastic, paint, and e-coat, the primers are particularly suited to use on glass surfaces.

The invention extends to primed and/or adhered substrates, such as:
1. A glass substrate with a layer of the primer compositions of the invention.
2. An adhered substrate comprising a glass substrate with a layer of the primer compositions of the invention over at least part of its surface and a layer of cured polyurethane-based adhesive adhesively in contact with the primer layer, the layer of cured polyurethane adhesive being further adhesively in contact with a second substrate.

Manufacture

The primer compositions of the invention can be manufactured by simply mixing the ingredients. For example, in a first step, the blocked aminosilane and the catalyst are first added to the solvent (e.g. MEK), in a second step the film former (if used) and the adhesion promoter are added. If desired, a stabilizer (e.g. diethyl malonate) and a latent cross-linker can be added in the first step. If desired, a crosslinker (e.g. a polyisocyanate) may be added in the second step. After addition of each component the mixture is thoroughly mixed. After all components are added the mixture is thoroughly mixed.

Preferably the process is carried out under an inert and low-humidity gas, such as nitrogen.

An example of manufacture of the primer compositions of the invention is as follows: A metallic (e.g. aluminium) mixing vessel is dried in an oven at above 100° C. in order to dry it (e.g. for 2 hours). The solvent (e.g. MEK) is first added to the bottles, followed by a stabilizer (if used), such as diethyl malonate, a latent crosslinker (if used), such as QM-1007, the blocked aminosilane (e.g. SID4068.0), and the catalyst (e.g. KKAT 670). Finally, a crosslinker (if used) such as isocyanate (e.g. Desmodur HL), the optional film former (e.g. polyester resin, such as VITEL 2301BU), and the adhesion promoter (e.g. organosilane, such as 170702) are added to the bottles. After each addition, the bottles are blanketed with nitrogen and the contents are mixed by shaking the bottle. After addition of all components, the contents are further mixed in a paint shaker.

Use

The invention provides a method of adhering a first and second substrate, comprising the steps of:
(1) applying to the surface of the first substrate, the second substrate or both a primer of the invention;
(2) applying a polyurethane-based adhesive to the first substrate, the second substrate or both in such a way that it will be in contact with the primer when the substrates are assembled; and
(3) assembling the first substrate and second substrate such that the adhesive is sandwiched between them.

After step 1 and before step 2 a drying step is carried out to remove the solvent. Removal of the solvent can be carried out by simply leaving the primer coated substrate at room temperature, for example, for 30 minutes. The solvent can also be driven off using forced air, or by applying a vacuum.

Steps 1 and 2 may be carried out in immediate succession, or an open time may be left between application of the primer and application of the polyurethane-based adhesive. The open time may be several hours or even several days, for example 30 to 90 days.

Subsequent to step 3, the adhesive is cured. The curing may occur immediately after the assembly in step 3, or it may be separated by a interval of a few minutes, a few hours or even days.

In a preferred embodiment, the first substrate is glass and the second substrate is metal, and the primer is preferably applied to the glass substrate.

The primers of the invention are used by applying them to at least one surface of at least one substrate. Usually a primer-soaked cloth (e.g. cheese cloth) is used to coat the substrate with the primer. The solvent may be allowed to evaporate, for example, by leaving the primed surface exposed to the atmosphere, by forcing air over the substrate or subjecting the substrate surface to reduced pressure. After evaporation of the solvent, an adhesion-promoting film is left on the substrate, generally of less than 1 mm thickness, preferably from 100 nm-100 micron thickness. A polyurethane adhesive is then put in contact with the primer and subsequently cured.

Adhesive Performance

The primers of the invention show good adhesive strength when paired with a polyurethane adhesive, as measured by lap shear testing. Lap shear testing is preferably carried out according to ASTM SAE J1529, as follows:
Glass coupon size=1 inch×3 inch
Bead size=6 mm wide×6 mm high
Initial cure=7 days at 50% RH and 25 C (other conditions as mentioned)
Pull rate=1 inch/min

Under these conditions, the primers of the invention in combination with a polyurethane-based adhesive preferably give a lap shear strength after 7 days, 25° C., 50% relative humidity (RH) of at least 600 MPa.

Under these conditions, the primers of the invention in combination with a polyurethane-based adhesive preferably give a lap shear strength after 7 days, 90° C. water soak of at least 380 MPa.

Open Time

Adhesive performance after a particular open time may be evaluated using a quick knife adhesion test:

The test is performed on 1-inch×6-inch glass coupons. One side of the coupon is covered with the ceramic frit. 2L5350, a sag-bent frit available from Johnson Matthey Inc. To perform the quick knife test, the primer is first applied by saturating a cheesecloth with the primer solution and applying a thin layer on the frit surface. After priming the frit-side the glass coupons are placed in an environmental chamber maintained at 30° C. and 80% relative humidity for the desired open time (7 days or 30 days). After the desired exposure in the environmental chamber, a urethane adhesive bead roughly 8-mm wide and 6-8 mm thick is applied on the primed frit surface. The adhesive is allowed to cure at 25° C. and 50% relative humidity for 7 days. After cure, quick knife test is performed by scoring the adhesive/substrate interface with a knife while pulling the adhesive back. The mode of failure is recorded for each sample as a combination of percentage cohesive failure within the adhesive bead (CF), percentage primer failure to substrate (PF), and percentage adhesive failure at the primer interface (AF).

The primers of the invention, when used with a polyurethane-based adhesive preferably show above 90%, more preferably above 95% cohesive failure after 7 days of open time before applying the adhesive, more preferably the show above 90%, more preferably above 95% cohesive failure after 30 days of open time before applying the adhesive.

As an additional evaluation of adhesive performance after prolonged open times, the adhered samples can be exposed to cataplasma conditions, designed to mimic adverse environmental conditions. Samples are prepared according to the above procedure and, after the desired open time, adhesive is applied and allowed to cure at 25° C. and 50% relative humidity for 7 days. The samples are then exposed to cataplasma conditions. To conduct cataplasma exposure, samples are placed in 70° C./100% relative humidity for 7 days. The samples are then wrapped in cotton wool soaked in water and sealed in a polyethylene bag. Next, the samples are placed in a freezer for 16 hours at −20° C., after which the sample stands at room temperature for 2 hours. Quick knife adhesion test is then conducted on the samples and the mode of failure was recorded.

The primers of the invention, when used with a polyurethane-based adhesive and exposed to cataplasma conditions, preferably show above 90%, more preferably above 95% cohesive failure after 7 days of open time before applying the adhesive, more preferably the show above 90%, more preferably above 95% cohesive failure after 30 days of open time before applying the adhesive.

TABLE 1
Raw material list

| | | | Manufacturer/ |
|---|---|---|---|
| Component | Composition | Function | Supplier |
| MEK | Methylethyl ketone | Solvent | Sigma Aldrich |
| Desmodur HL | TDI/HDI polyisocyanate in butyl | Crosslinker | Covestro |
| | acetate | | |
| Silane | Reaction product of 3- | Adhesion | DuPont |
| Intermediate | mercaptopropyltrimethoxysilane | promoter | |
| (170702)¹ | (Silquest A 189) and HDI biuret | | |
| | (Desmodur N100) | | |
| Paraloid | Oxazolidine based reactive | Latent | Dow Chemical |
| QM-1007 | modifier | crosslinker | |
| DEM | Diethyl Malonate | Stabilizer | Sigma Aldrich |
| Vitel 2301 BU | A polyester film-forming resin | Film former | Bostik |
| | made from iso-phthalate, dimethyl | | |
| | terephthalate, neo-pentyl glycol | | |
| | and ethylene glycol (40% resin in | | |
| | MEK) | | |
| KKAT 670 | Zinc carboxylate | Catalyst | King |
| | | | Industries |
| SID4068.0 | 3-(1,3-Dimethylbutylidene)amino- | Blocked | Gelest Inc. |
| | propyltriethoxysilane | aminosilane | |
| | | Latent | |
| | | adhesion | |
| | | promoter | |
| Sivate E610 | blend of aminopropyltriethoxysilane, | Adhesion | Gelest Inc. |
| | 1,2-bis(triethoxysilyl)ethane, and | promoter | |
| | bis(3-triethoxysilylpropyl)amine | | |
| Silquest A189 | 3-mercaptopropyltrimethoxysilane | Adhesion | Momentive |
| | | promoter | |
| Tyzor OGT | Lewis acid catalyst | Catalyst | Dorf Ketal |
| | Reactive octyleneglycol titanate | | |
| Polyurethane | A one-component, moisture | Adhesive | |
| adhesive | curing, high viscosity | | |
| | polyurethane adhesive | | |
| | comprising an MDI based | | |
| | urethane prepolymer, diisononyl | | |
| | phthalate (plasticizer), carbon | | |
| | black, and clay | | |
| Desmodur N100 | A trimer of | Precursor | Covestro |
| | hexamethylenediisocyanate | | |

¹Prepared according to U.S. Pat. No. 5,238,993, incorporated herein by reference

### EXAMPLES

### Examples 1, 2, and 3 (Inventive)

Primers were prepared according to the compositions listed in Error! Reference source not found. Inventive compositions are designated with an “E”, and comparative Examples are designated with “CE”. 100-mL aluminum bottles were dried in an oven at 110° C. for 2 hours prior to use. MEK was first added to the bottles, followed by diethyl malonate, QM-1007, SID4068.0 (the blocked aminosilane), and KKAT 670. Finally, isocyanate (Desmodur HL), polyester resin (VITEL 2301BU), and the organosilane intermediate (170702) were added to the bottles. After each addition, the bottles were blanketed with nitrogen and the contents were mixed by shaking the bottle by hand. After addition of all components, the contents were further mixed in a paint shaker for 10 minutes.

### Comparative Examples 4, 5, and 6

Primers without the blocked aminosilane (SID4068.0) were prepared in a similar manner using the procedure described above.

TABLE 2
Composition of primers (wt %)

| | | | Desmodur | Vitel | QM- | Diethyl | KKAT | |
|---|---|---|---|---|---|---|---|---|
| | MEK | 170702 | HL | 2301BU | 1007 | Malonate | 670 | SID4068.0 |
| E1 | 43.70 | 20.00 | 20.00 | 10.00 | 3.18 | 0.12 | 1.00 | 2.00 |
| E2 | 43.70 | 16.67 | 16.67 | 16.67 | 3.18 | 0.12 | 1.00 | 2.00 |
| E3 | 43.70 | 10.00 | 10.00 | 30.00 | 3.18 | 0.12 | 1.00 | 2.00 |
| CE4 | 45.70 | 20.00 | 20.00 | 10.00 | 3.18 | 0.12 | 1.00 | 0 |
| CE5 | 45.70 | 16.67 | 16.67 | 16.67 | 3.18 | 0.12 | 1.00 | 0 |
| CE6 | 45.70 | 10.00 | 10.00 | 30.00 | 3.18 | 0.12 | 1.00 | 0 |

Polyurethane Adhesive

The tests were performed using a polyurethane adhesive comprising the following:

Isocyanate-terminated prepolymer

| Raw Material | Chemistry |
|---|---|
| Voranol 220-056 | a nominally difunctional, poly(propylene oxide) |
| | having a hydroxyl number of 56 (equivalent weight |
| | 1000) |
| Voranol 232-036N | a nominally trifunctional poly(propylene oxide) |
| | having a hydroxyl number of 36 (equivalent weight |
| | 1558) |
| Palatinol N | Diisononyl Phthalate |
| Isonate 125M | 4,4′-diphenylmethane diisocyanate |
| Dabco T-9 | Stannous 2-Ethylhexanoate |
| Diethyl malonate | Diethyl malonate |

Polyurethane-based adhesive

| Raw Material | Chemistry |
|---|---|
| Isocyanate-terminated prepolymer | |
| (such as the prepolymer described | |
| in the above table) | |
| ELFTEX S7100 | Carbon black |
| Iceburg Clay | Kaolin clay |
| Palatinol N | Diisononyl Phthalate |
| Bismuth Octoate | Bismuth 2-Ethylhexanoate |
| JEFFCAT DMDEE | Morpholine, 4,4′-(Oxydi-2,1- |
| | ethanediyl)bis |

Adhesion Tests

Adhesion was tested using lap shear tests. To conduct lap shear tests, 1-inch×3-inch sized glass coupons with a 2-inch band of ceramic enamel were used. Two types of enamels (frits) were tested: AD3402 (press bent glass frit available from Ferro Corp.) and 2L5350 (sag bent frit available from Johnson Matthey Inc.) The primer was first applied by saturating a cheesecloth with the primer solution and spreading a thin layer on the frit surface. After 30 min, 6-8 mm thick polyurethane adhesive bead was applied along the width of the primed coupon approximately 6 mm from the primed end. After applying the urethane adhesive bead, an e-coat coupon primed with a polyurethane-based moisture curing body primer comprising MEK and acetone, polyisocyanates, polyester resin, talc and carbon black, was then immediately placed on the adhesive. The e-coat coupon was pressed to create a lap joint with a bond thickness of 3 mm. The coupons were stored at 50% relative humidity and 25° C. for 7 days. The lap joint was pulled at the rate of 1 inch/min with an Instron tester. Another set of samples were cured for 7 days at 50% relative humidity and 25° C. for 7 days and then immersed in a hot water bath kept at 90° C. for 7 days. After 7 days, the samples were allowed to dry for 24 hours and the lap joint was pulled using the process described above.

Table 3 shows the lap shear data comparing the performance of the three inventive primers (E1, E2, and E3) with the three comparative primers (CE4, CE5, and CE6). The lap shear specimens with the inventive primer show excellent bond strength after room temperature cure and after hot water immersion on both frits. The mode of failure on all specimens is 100% cohesive failure indicating good interfacial strength of the primer. In addition, no blistering is observed in the three inventive primers after hot water soak.

Lap shear specimen prepared with the comparative primers (CE4, CE5 and CE6) show good strength after room temperature cure with 100% cohesive failure. However, the performance of primers CE5 and CE6 after hot water immersion is less than desirable. For instance, one 2L5350 coupon primed with CE5 primer shows 40% primer failure after water immersion and one AD3402 coupon primed with the same primer shows 20% primer failure after water immersion. In the case of CE6, one AD3402 coupon shows 40% primer failure after water immersion. In addition, primer of CE6 shows high amount of blistering after water soak, indicating poor hydrolytic stability of the primer film.

TABLE 2
Lap shear tests conducted on two frits (2L5350 and AD3402) using polyurethane adhesive. Lap
shear strength values are mentioned in psi and the mode of failure is reported as percentage
of cohesive failure (CF) or primer failure at the enamel (PF) or a combination of both.

| | Enamel: 2L5350 | | Enamel: AD3402 | |
|---|---|---|---|---|
| | 7 days, 25° C., | 7 days, 90° C. | 7 days, 25° C., | 7 days, 90° C. |
| | 50% RH | water soak | 50% RH | water soak |
| E1 | 695.5/100CF | 424.2/100CF | 621.2/90CF, 10PF | 411.2/100CF |
| | 639.2/100CF | 440.4/100CF | 549.5/100CF | 427.1/100CF |
| | 588.1/100CF | 408.7/100CF | 632.5/100CF | 391/100CF |
| Average | 641 | 424 | 601 | 410 |
| Blistering | — | No | — | No |
| E2 | 574.8/100CF | 404.6/100CF | 713.5/100CF | 422.3/100CF |
| | 648.5/100CF | 398.3/100CF | 615.4/100CF | 401.2/100CF |
| | 600.8/100CF | 348.3/100CF | 699.4/100CF | 429.9/100CF |
| Average | 608 | 384 | 676 | 418 |
| Blistering | — | No | — | No |
| E3 | 713.7/100CF | 367.6/100CF | 976.2/100CF | 356.1/100CF |
| | 574.5/100CF | 380.3/100CF | 746.6/100CF | 422/100CF |
| | 573.9/100CF | 398.8/100CF | 781.8/100CF | 446.8/100CF |
| Average | 621 | 382 | 835 | 408 |
| Blistering | — | No | — | No |
| CE4 | 681.8/100CF | 429.3/100CF | 740.9/100CF | 411.0/100CF |
| (Comparative) | 806.8/100CF | 422.6/100CF | 579.4/100CF | 398.3/100CF |
| | 551.4/100CF | 337.9/100CF | 550.6/100CF | 444.6/100CF |
| | 680 | 397 | 624 | 418 |
| Blistering | — | No | — | No |
| CE5 | 554.7/100CF | 314.4/60CF, 40PF | 585.6/100CF | 358.9/80CF 20PF |
| (Comparative) | 526.8/100CF | 399.4/100CF | 589.5/100CF | 426.1/100CF |
| | 537.8/100CF | 417.3/100CF | 569.2/100CF | 352.1/100CF |
| Average | 540 | 377 | 581 | 379 |
| Blistering | — | No | — | No |
| CE6 | 623.8/100CF | 318.7/80CF, 20PF | 717.5/100CF | 264.7/60CF, 40PF |
| (Comparative) | 567.5/100CF | 374.3/90CF, 10PF | 650.6/100CF | 396.0/100CF |
| | 681.7/100CF | 427.3/100CF | 859.7/100CF | 396.1/100CF |
| Average | 624 | 373 | 743 | 352 |
| Blistering | — | Yes | — | Yes |

A quick knife adhesion test was performed on 1-inch×6-inch glass coupons. One side of the coupon was covered with the ceramic frit. 2L5350, a sag-bent frit available from Johnson Matthey Inc. To perform the quick knife test, the primer was first applied by saturating a cheesecloth with the primer solution and applying a thin layer on the frit surface. After priming the frit-side the glass coupons were placed in an environmental chamber maintained at 30° C. and 80% relative humidity for the desired open time (7 days or 30 days). After the desired exposure in the environmental chamber, a urethane adhesive bead roughly 8-mm wide and 6-8 mm thick was applied on the primed frit surface. The adhesive was allowed to cure at 25° C. and 50% relative humidity for 7 days. After cure, quick knife test was performed by scoring the adhesive/substrate interface with a knife while pulling the adhesive back. The mode of failure was recorded for each sample as a combination of percentage cohesive failure within the adhesive bead (CF), percentage primer failure to substrate (PF), and percentage adhesive failure at the primer interface (AF).

Another set of samples were prepared according to the above procedure and adhesive was allowed to cure at 25° C. and 50% relative humidity for 7 days. The samples were then exposed to cataplasma condition. To conduct cataplasma exposure, samples were placed in 70° C./100% relative humidity for 7 days. The samples are then wrapped in cotton wool soaked in water and sealed in a polyethylene bag. Next, the samples are placed in a freezer for 16 hours at −20° C., after which the sample can stand at room temperature for 2 hours. Quick knife adhesion test was then conducted on the samples and the mode of failure was recorded.

TABLE 3
Quick knife test conducted on primers applied on 2L5350 frit. Polyurethane adhesive
was applied after exposing primed frit to 30° C. and 80% relative humidity
for 7 days and 30 days. Quick knife adhesion tests were conducted after 7 days
cure of urethane adhesive at 25° C., 50% RH and after cataplasma test.

| | Open Time | | | |
|---|---|---|---|---|
| | 7 days open time, 30° C., | | 30 days open time, 30° C., | |
| | 80% RH | | 80% RH | |
| | Test condition | | | |
| | 7 days, 25° | | 7 days, 25° | |
| | C., 50% RH | Cataplasma | C., 50% RH | Cataplasma |
| E1 | 100CF | 100CF | 100CF | 100CF |
| | 100CF | 100CF | 100CF | 100CF |
| | 100CF | 100CF | 100CF | 100CF |
| E2 | 100CF | 100CF | 100CF | 100CF |
| | 100CF | 100CF | 100CF | 100CF |
| | 100CF | 100CF | 100CF | 100CF |
| E3 | 100CF | 100CF | 100CF | 100CF |
| | 100CF | 100CF | 100CF | 100CF |
| | 100CF | 100CF | 100CF | 100CF |
| CE4 | 100CF | 100CF | 100CF | 100CF |
| (Comparative) | 100CF | 40CF, 60PF | 100CF | 60CF, 40PF |
| | 100CF | 100CF | 100CF | 100CF |
| CE5 | 100CF | 100CF | 100CF | 0CF, 100PF |
| (Comparative) | 100CF | 0CF, 100PF | 100CF | 0CF, 100PF |
| | 100CF | 100CF | 100CF | 40CF, 60TFCF |
| CE6 | 100CF | 100CF | 100CF | 100CF |
| (Comparative) | 100CF | 100CF | 100CF | 100CF |
| | 100CF | 100CF | 100CF | 100CF |

Table 3 shows the performance of the primers after extended open time conditions. Inventive primers (E1, E2, and E3) all pass the quick knife adhesion tests after room temperature cure and after cataplasma exposure for both open time conditions. Two comparative primers, on the other hand, had less than desirable results. For instance, primer of CE4 showed 60% primer failure in one quick knife adhesion coupon in the 7 days open time condition after cataplasma exposure. Another coupon also shows 40% primer failure in the 30 days open time condition after cataplasma exposure.

Similarly, in the case of CE5, 100% primer failure is observed on one coupon in the 7 days open time condition after cataplasma exposure. The primer also fails in the 30 days open time condition after cataplasma exposure with two coupons showing 100% primer failure. The primer of CE6 shows good open time performance. However, this primer fails in the water immersion condition, as shown in Table 2, indicating poor hydrolytic stability.

### Examples 7 and 8 (Inventive)

Primers were prepared according to the compositions listed in Table 4Error! Reference source not found. The primers were prepared in a 100-mL aluminum bottle, which was first dried in an oven at 110° C. for 2 hours prior to use. MEK was first added to the bottle, followed by Silquest A189, Sivate E610, VITEL 2301BU, SID4068.0, and KKAT 670. The bottle was blanketed with nitrogen and the contents were shaken by hand. Tyzor OGT was then added and the contents were mixed in a paint shaker for 10 minutes.

### Comparative Example 9

Primers without the blocked aminosilane (SID4068.0) were prepared in a similar manner using the procedure described above.

TABLE 4
Composition of primers

| | Silquest | Tyzor | Sivate | Vitel | KKAT | | |
|---|---|---|---|---|---|---|---|
| | A189 | OGT | E610 | 2301BU | 670 | MEK | SID4068.0 |
| E7 | 3.69 | 3.37 | 1.57 | 10 | 0.23 | 81.14 | 0.50 |
| E8 | 3.69 | 3.37 | 1.57 | 10 | 0.23 | 81.14 | 1.00 |
| CE9 | 3.69 | 3.37 | 1.57 | 10 | 0.23 | 81.14 | 0.00 |

Lap shear coupons were prepared according to the procedure described above. Glass coupons coated with 2L5350 ceramic enamel were used. Primer was applied on the frit side of the glass and the coupons were placed in an environmental chamber maintained at 30° C. and 80% relative humidity. The coupons were removed from the chamber after the desired open time: 7 days or 30 days. Lap joints were prepared using the primer coated glass coupons and e-coat coupons primed with a polyurethane-based moisture curing body primer, comprising solvents (MEK and acetone), polyisocyanates, polyester resin, talc, and carbon black. A one-component, moisture curing, high viscosity polyurethane adhesive comprising an MDI based urethane prepolymer, diisononyl phthalate (plasticizer), carbon black, and clay was used as the urethane adhesive. Three lap shear joints were prepared for each condition. The lap joints were pulled using an Instron tester after 7 days at 25° C. and 50% relative humidity and after Cataplasma exposure using the procedure described previously. Results from the lap shear test are shown in Error! Reference source not found.

All three primers perform well in the 7 days room temperature cure condition for both open times. All specimens show 100% cohesive failure, indicating good interfacial strength of the primer. However, significant differences in the performance can be seen after Cataplasma exposure. In the 7 days open time condition, the primers of E7 and E8 show good lap shear strength (greater than 500 psi) and 100% CF as the mode of failure. On the other hand, the primer of CE9 shows poor lap shear strength and the mode of failure was primarily primer failure. Similarly, in the 30 days open time condition, the primers of E7 and E8 perform well with >500 psi lap shear strength and primarily cohesive failure in the urethane as the mode of the failure. The primer of CE9, on the other hand, shows low lap shear strength and the mode of failure is mostly primer failure.

TABLE 5
Lap shear tests conducted using polyurethane adhesive and 2L5350 frit
coupons. Lap shear strength values are mentioned in psi and the mode
of failure is reported as percentage of cohesive failure (CF) or
primer failure at the enamel (PF) or a combination of both.

| | Open time | | | |
|---|---|---|---|---|
| | 7 days 30° C./80% RH | | 30 days 30° C./80% RH | |
| | Test condition | | | |
| | 7 days, 25° | | 7 days, 25° | |
| | C., 50% RH | Cataplasma | C., 50% RH | Cataplasma |
| E7 | 676/100CF | 589/100CF | 657/100CF | 482/70CF, 30PF |
| | 571/100CF | 606/100CF | 596/100CF | 527/90CF, 10PF |
| | 653/100CF | 533/100CF | 563/100CF | 499/80CF, 20PF |
| Average | 633 | 576 | 605 | 506 |
| E8 | 765/100CF | 569/100CF | 681/100CF | 541/95CF, 5PF |
| | 654/100CF | 491/100CF | 658/100CF | 635/100CF |
| | 808/100CF | 504/100CF | 867/100CF | 511/100CF |
| Average | 742 | 521 | 735 | 563 |
| CE9 | 630/100CF | 287/30CF, 70PF | 668/100CF | 316/10CF, 90PF |
| (Comparative) | 644/100CF | 340/10CF, 90PF | 773/100CF | 259/100PF |
| | 503/100CF | 257/5CF, 95PF | 768/100CF | 243/100PF |
| Average | 592 | 294 | 736 | 273 |

1. A primer composition for urethane-based adhesives, comprising: a) at least one adhesion promoter; b) at least one catalyst; c) at least one solvent; and d) at least one blocked amino-silane with the following formula: 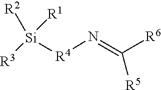
where R¹ is OCH₃ or OC₂H₅;
R² and R³ are independently selected from OCH₃, OC₂H₅, and CₘH₂ₘ₊₁ where m is an integer of 1 to 5;
R⁴ is CₙH₂ₙ where n is an integer of 1 to 12;
R⁵ is H or CₚH₂ₚ₊₁, branched or unbranched, where p is an integer of 1 to 10;
R⁶ is C_{q}H_{2q+1}, branched or unbranched, where q is an integer of 1 to 10.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. The primer composition of claim 1, wherein R¹ is OC₂H₅, R² and R³ are independently selected from OCH₃, OC₂H₅ and OC₃H₇, R⁴ is CₙH₂ₙ where n is an integer of 1 to 4, R⁵ is selected from H or CₚH₂ₚ₊₁, branched or unbranched, where p is an integer of 1 to 5, R⁶ is selected from C_{q}H_{2q+1}, branched or unbranched, where q is an integer of 1 to 5.

14. The primer composition of claim 1, wherein R² and R³ are independently selected from OCH₃ and OC₂H₅, n is 3, p is 4, and q is 4.

15. The primer composition of claim 1, wherein the blocked aminosilane is 3-(1,3-dimethylbutylidene)aminopropyltriethoxysilane.

16. (canceled)

17. The primer composition of claim 1, wherein the adhesion promoter is selected from compounds of the general formula (R¹O)₃—Si—R²X and (R¹O)₂—(R³)Si—OR²X, where R¹ is independently selected from a substituted or unsubstituted alkyl group or acyl group, X is a group functionalized with a glycidyl, amino, methacryloxy, or isocyanate group, R³ is substituted or unsubstituted C₁₋₆ alkyl.

18. The primer composition of claim 1, wherein in the adhesion promoter R¹ is selected from methyl, ethyl, 2-methoxyethyl and acetyl.

19. (canceled)

20. The primer composition of claim 1, wherein in the adhesion promoter X is a group functionalized with at least one amino or isocyanate group.

21. (canceled)

22. The primer composition of claim 1, wherein the adhesion promoter comprises a reaction product of HDI-biuret and 3-mercaptopropyltrimethoxysilane.

23. The primer composition of claim 1, which additionally comprises one or more cross-linkers.

24. The primer composition of claim 23, wherein the one or more cross-linker is one or more polyisocyanate.

25. The primer composition of claim 24, wherein the one or more polyisocyanate is TDI/HDI polyisocyanate.

26. A method for priming a substrate, comprising the step of applying on the surface of the substrate a primer comprising: a) at least one adhesion promoter; b) at least one catalyst; c) at least one solvent; and d) at least one blocked amino-silane with the following formula: 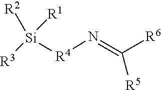
where R¹ is OCH₃ or OC₂H₅;
R² and R³ are independently selected from OCH₃, OC₂H₅, and CₙH₂ₙ+1 where n is an integer of 1 to 5;
R⁴ is CₙH₂ₙ where n is an integer of 1 to 12;
R⁵ is H or CₙH₂ₙ+1 where n is an integer of 1 to 10;
R⁶ is CₙH₂ₙ+1 where n is an integer of 1 to 10.

27. A method of adhering a first and second substrate, comprising the steps of:
(1) applying to the surface of the first substrate, the second substrate or both a primer comprising: a) at least one adhesion promoter; b) at least one catalyst; c) at least one solvent; and d) at least one blocked amino-silane with the following formula: 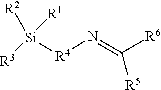
where R¹ is OCH₃ or OC₂H₅;
R² and R³ are independently selected from OCH₃, OC₂H₅, and CₙH₂ₙ+1 where n is an integer of 1 to 5;
R⁴ is CₙH₂ₙ where n is an integer of 1 to 12;
R⁵ is H or CₙH₂ₙ+1 where n is an integer of 1 to 10;
R⁶ is CₙH₂ₙ+1 where n is an integer of 1 to 10;
(2) allowing the solvent to evaporate;
(3) applying a polyurethane-based adhesive to the first substrate, the second substrate or both in such a way that it will be in contact with the primer when the substrates are assembled; and
(4) assembling the first substrate and second substrate such that the adhesive is sandwiched between them.

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. The method of claim 26, wherein R¹ is OC₂H₅, R² and R³ are independently selected from OCH₃, OC₂H₅ and OC₃H₇, R⁴ is CₙH₂ₙ where n is an integer of 1 to 4, R⁵ is selected from H or CₚH₂ₚ₊₁, branched or unbranched, where p is an integer of 1 to 5, R⁶ is selected from C_{q}H_{2q+1}, branched or unbranched, where q is an integer of 1 to 5.

40. The method of claim 26, wherein R² and R³ are independently selected from OCH₃ and OC₂H₅, n is 3, p is 4, and q is 4.

41. The method of claim 26, wherein the blocked aminosilane is 3-(1,3-dimethylbutylidene)aminopropyltriethoxysilane.

42. (canceled)

43. The method of claim 26, wherein the adhesion promoter is selected from compounds of the general formula (R¹O)₃—Si—R²X and (R¹O)₂—(R³)Si—OR²X, where R¹ is independently selected from a substituted or unsubstituted alkyl group or acyl group, X is a group functionalized with a glycidyl, amino, methacryloxy, or isocyanate group, R³ is substituted or unsubstituted C₁₋₆ alkyl.

44. The method of claim 26, wherein in the adhesion promoter R¹ is selected from methyl, ethyl, 2-methoxyethyl and acetyl.

45. (canceled)

46. The method of claim 26, wherein in the adhesion promoter X is a group functionalized with at least one amino or isocyanate group.

47. (canceled)

48. The method of claim 26, wherein the adhesion promoter comprises a reaction product of HDI-biuret and 3-mercaptopropyltrimethoxysilane.

49. (canceled)

50. (canceled)
